(19) United States
(12) Patent Application Publication
(10) Pub. No.: US 2009/0150894 A1
(43) Pub. Date: Jun. 11, 2009

(54) Nonvolatile memory (NVM) based solid-state disk (SSD) system for scaling and quality of service (QoS) by parallelizing command execution

(76) Inventors: Ming Huang, Oak Park, CA (US); Zhiqing Zhuang, Irvine, CA (US)

Correspondence Address: Ming Huang, 984 Blackbourne Point, Oak Park, CA, 91377, US

(21) Appl. No.: 11/953,080

(22) Filed: Dec. 10, 2007

(51) Int. Cl. G06F 12/02; G06F 9/46; G06F 13/28

(52) U.S. Cl. 718/104; 711/103; 710/22; 711/E12.017; 711/E12.008

(57) ABSTRACT

A method for scaling a SSD system which includes providing at least one storage interface and providing a flexible association between storage commands and a plurality of processing entities via the plurality of nonvolatile memory access channels. Each storage interface associates a plurality of nonvolatile memory access channels.

### CROSS REFERENCE TO RELATED APPLICATIONS

This application claims priority to U.S. Provisional Application No. 60/875,316 filed on Dec. 18, 2006 which is incorporated in its entirety by reference herein.

### BACKGROUND OF THE INVENTION

1. Field of the Invention

The present invention relates to SSD and more particularly to parallelizing storage commands.

2. Description of the Related Art

In known computer systems, the storage interface functionality is treated and supported as an undifferentiated instance of a general purpose Input Output (I/O) interface. This treatment is because computer systems are optimized for computational functions, and thus SSD specific optimizations might not apply to generic I/O scenarios. A generic I/O treatment results in no special provisions being made to favor storage command idiosyncrasies. Known computer systems include laptop/notebook computers, platform servers, server based appliances and desktop computer systems.

Known storage interface units, PATA/IDE, SATA, SCSI, SAS, Fiber Channel and iSCSI include internal architectures to support their respective fixed function metrics. In the known architectures, low-level storage command processing is segregated to separate hardware entities residing outside the general purpose processing system components.

The system design tradeoffs associated with computer systems, just like many other disciplines, include balancing functional efficiency against generality and modularity. Generality refers to the ability of a system to perform a large number of functional variants, possibly through deployment of different software components into the system or by exposing the system to different external commands. Modularity refers to the ability to use the system as a subsystem within a wide array of configurations by selectively replacing the type and number of subsystems interfaced.

It is desirable to develop storage systems that can provide high functional efficiencies while retaining the attributes of generality and modularity. Storage systems are generally judged by a number of efficiencies relating to storage throughput (i.e., the aggregate storage data movement ability for a given traffic data profile), storage latency (i.e., the system contribution to storage command latency), storage command rate (i.e., the system's upper limit on the number of storage commands processed per time unit), and processing overhead (i.e., the processing cost associated with a given storage command). Different uses of storage systems are more or less sensitive to each of these efficiency aspects. For example, bulk data movement commands such as disk backup, media streaming and file transfers tend to be sensitive to storage throughput, transactional uses, such as web servers, tend to also be sensitive to storage command rate.

Scalability is the ability of a system to increase its performance in proportion to the amount of resources provided to the system, within a certain range. Scalability is another important attribute of storage systems. Scalability underlies many of the limitations of known I/O architectures. On one hand, there is the desirability of being able to augment the capabilities of an existing system over time by adding additional computational resources so that systems always have reasonable room to grow. In this context, it is desirable to architect a system whose storage efficiencies improve as processors are added to the system. On the other hand, scalability is also important to improve system performance over time, as subsequent generations of systems deliver more processing resources per unit of cost or unit of size.

The SSD function, like other I/O functions, resides outside the memory coherency domain of multiprocessor systems. SSD data and control structures are memory based and access memory through host bridges using direct memory access (DMA) semantics. The basic unit of storage protocol processing in known storage systems is a storage command. Storage commands have well defined representations when traversing a wire or storage interface, but can have arbitrary representations when they are stored in system memory. Storage interfaces, in their simplest forms, are essentially queuing mechanisms between the memory representation and the wire representation of storage commands.

There are a plurality of limitations that affect storage efficiencies. For example, the number of channels between a storage interface and flash modules is constrained by a need to preserve storage command arrival ordering. Also for example, the number of processors servicing a storage interface is constrained by the processors having to coordinate service of shared channels, when using multiple processors; it is difficult to achieve a desired affinity between stateful sessions and processors over time. Also for example, a storage command arrival notification is asynchronous (e.g., interrupt driven) and is associated with one processor per storage interface. Also for example, the I/O path includes at least one host bridge and generally one or more fanout switches or bridges, thus degrading DMA to longer latency and lower bandwidth than processor memory accesses. Also for example, multiple storage command memory representations are simultaneously used at different levels of a storage command processing sequence with consequent overhead of transforming representations. Also for example, asynchronous interrupt notifications incur a processing penalty of taking an interrupt. The processing penalty can be disproportionately large considering a worst case interrupt rate.

One challenge in storage systems relates to scaling storage command, i.e., to parallelizing storage command. Parallelization via storage command load balancing is typically performed outside of the computing resources and is based on information embedded inside the storage command. Thus the decision may be stateful (i.e., the prior history of similar storage commands affects the parallelization decision of which computing node to use for a particular storage command), or the decision may be stateless (i.e., the destination of the storage command is chosen based on the information in the storage command but unaffected by prior storage commands).

An issue relating to parallelization is that loose coupling of load balancing elements limits the degree of collaboration between computer systems and the parallelizing entity. There are a plurality of technical issues that are not present in a traditional load balancing system (i.e., a single threaded load balancing system). For example, in a large simultaneous multiprocessing (SMP) system with multiple partitions, it is not sufficient to identify the partition to process a storage command, since the processing can be performed by one of many threads within a partition. Also, the intra partition communication overhead between threads is significantly lower than inter partition communication, which is still lower than node to node communication overhead. Also, resource management can be more direct and simpler than with traditional load balancing systems. Also, a SMP system may have more than one storage interface.

### SUMMARY OF THE INVENTION

In accordance with the present invention, a storage system is set forth which enables scaling by parallelizing a storage interface and associated command processing. The storage system is applicable to more than one interface simultaneously. The storage system provides a flexible association between command quanta and processing resource based on either stateful or stateless association. The storage system enables affinity based on associating only immutable command elements. The storage system is partitionable, and thus includes completely isolated resource per unit of partition. The storage system is virtualizable, with programmable indirection between a command quantum and partitions.

In one embodiment, the storage system includes a flexible non-strict classification scheme. Classification is performed based on command type, destination address, and resource availability.

Also, in one embodiment, the storage system includes optimistic command matching to maximize channel throughput. The storage system supports the commands in both Command Queue format and non Command Queue format. The Command Queue is one of a Tagged Command Queue (TCQ) and a Native Command Queue (NCQ) depending on the storage protocol. The storage system includes a flexible flow table format that supports both sequent command matching and optimistic command matching.

Also, in one embodiment, the storage system includes support for separate interfaces for different partitions for frequent operations. Infrequent operations are supported via centralized functions.

Also, in one embodiment, the system includes a channel address lookup mechanism which is based on the Logical Block Address (LBA) from the media access command. Each lookup refines the selection of a process channel.

Also, in one embodiment, the storage system addresses the issue of mutex contention overheads associated with multiple consumers sharing a resource by duplicating data structure resources.

Also, in one embodiment, the storage system provides a method for addressing thread affinity and as well as a method for avoiding thread migration.

In one embodiment, the invention relates to a method for scaling a storage system which includes providing at least one storage interface and providing a flexible association between storage commands and a plurality of nonvolatile memory modules via the plurality of nonvolatile memory access channels. Each storage interface including a plurality of memory access channels.

In another embodiment, the invention relates to a storage interface unit for scaling a storage system having a plurality of processing channels, which includes a nonvolatile memory module, a nonvolatile memory module controller, a storage command classifier, and a media processor. The nonvolatile memory module has a plurality of nonvolatile memory dies or chips. The storage command classifier provides a flexible association between storage commands and the plurality of nonvolatile memory modules via the plurality of memory access channels.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of the functional components of the asymmetrical processing architecture of the present invention.

FIG. 2 shows a block diagram of a software view of the storage system.

FIG. 3 shows a block diagram of the flow of storage command data and associated control signals in the storage system from the operational perspective.

FIG. 4 shows a block diagram of a storage interface unit.

FIG. 5 shows a block diagram of a storage command processor including a RX command queue module, a TX command queue module, and a storage command classifier module.

FIG. 6 shows a block diagram of a storage media processor including a channel address lookup module, and a Microprocessor module.

FIG. 7 shows a schematic block diagram of an example of a SATA storage protocol processor.

FIG. 8 shows a schematic block diagram of an example of a SAS storage protocol processor.

FIG. 9 shows a schematic block diagram of an example of a Fiber Channel storage protocol processor.

FIG. 10 shows a schematic block diagram of an example of a iSCSI storage protocol processor.

FIG. 11 shows a schematic block diagram of a nonvolatile memory system with multiple flash modules.

FIG. 12 shows a schematic block diagram of a nonvolatile memory channel processor.

### DETAILED DESCRIPTION

### Storage System Overview

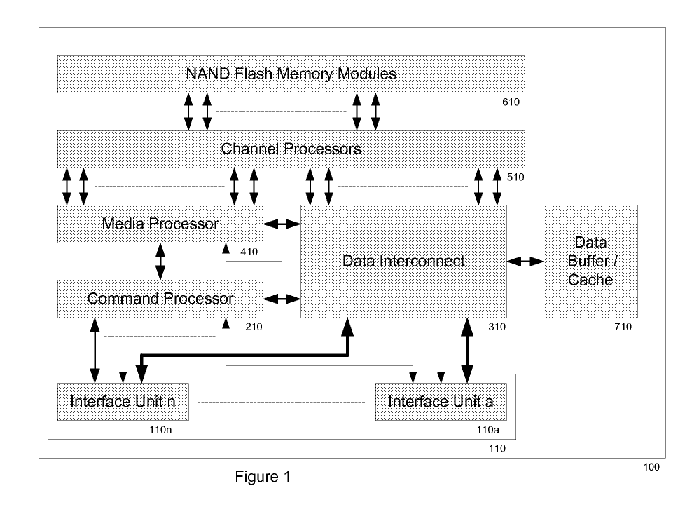

Referring to FIG. 1, a block diagram of a storage system 100 is shown. More specifically, the storage system 100 includes a storage interface subsystem 110, a command processor 210, a data interconnect module 310, a media processor 410, a channel processor subsystem 510, a nonvolatile memory die/chip subsystem 610, and a data buffer/cache module 710.

The storage interface subsystem 110 includes multiple storage interface units. A storage interface unit includes a storage protocol processor 160, a RX command FIFO 120, a TX command FIFO 130, a RX data FIFO/DMA 140, and a TX data FIFO/DMA 150.

The storage protocol processor 160 may be one of an ATA/IDE, SATA, SCSI, SAS, iSCSI, and Fiber Channel protocol processor.

The command processor module 210 may be a processor, a group of processors, a processor core, a group of processor cores, a processor thread or a group of processor threads or any combination of processors, processor cores or processor threads. The module also includes a command queuing system and associated hardware and firmware for command classifications.

The data interconnect module 310 is coupled to the storage interface subsystem 110, the command processor module 210, and the media processor 410. The module is also coupled to a plurality of channel processors 510 and to the data buffer/cache memory system 710.

The media processor module 410 may be a processor, a group of processors, a processor core, a group of processor cores, a processor thread or a group of processor threads or any combination of processors, processor cores or processor threads. The module includes a channel address lookup table for command dispatch. The module also includes hardware and firmware for media management and command executions.

The storage channel processor module 510 includes multiple storage channel processor. A single channel processor may include a plurality of processor cores and each processor core may include a plurality of processor threads. Each channel processor also includes a corresponding memory hierarchy. The memory hierarchy includes, e.g., a first level cache (such as cache 560), a second level cache (such as cache 710), etc. The memory hierarchy may also include a processor portion of a corresponding non-uniform memory architecture (NUMA) memory system.

The nonvolatile memory subsystem 610 may include a plurality of nonvolatile memory modules. Each individual nonvolatile memory module may include a plurality of individual nonvolatile memory dies or chips. Each individual nonvolatile memory module is coupled to a respective channel processor 510.

The data buffer/cache memory subsystem 710 may include a plurality of SDRAM, DDR SDRAM, or DDR2 SDRAM memory modules. The subsystem may also include at least one memory interface controller. The memory subsystem is coupled to the rest of storage system via the data interconnect module 310.

The storage system 100 enables scaling by parallelizing a storage interface and associated processing. The storage system 100 is applicable to more than one interface simultaneously. The storage system 100 provides a flexible association between command quanta and processing resource based on either stateful or stateless association. The storage system 100 enables affinity based on associating only immutable command elements. The storage system 100 is partitionable, and thus includes completely isolated resource per unit of partition. The storage system 100 is virtualizable.

The storage system 100 includes a flexible non-strict classification scheme. Classification is performed based on command types, destination address, and requirements of QoS. The information used in classification is maskable and programmable. The information may be immutable (e.g., 5-tuple) or mutable (e.g., DSCP).

Also, the storage system 100 includes support for separate interfaces for different partitions for frequent operations using the multiple channel processors. Infrequent operations are supported via centralized functions (e.g., via the command processor and media processor).

In one embodiment, the storage system 100 includes a storage interface unit for scaling of the storage system 100. The storage interface unit includes a plurality of nonvolatile memory access channels, a storage command processor, and a media processor. The storage command processor provides a flexible association between storage commands and a plurality of nonvolatile memory modules via the plurality of channel processors.

The storage interface unit includes one or more of a plurality of features. For example, the flexible association may be based upon stateful association or the flexible association may be based upon stateless association. Each of the plurality of channel processors includes a channel context. The flexible association may be provided via a storage command classification process. The storage command classification includes performing a non-strict classification on a storage command and associating the storage command with one of the plurality of nonvolatile memory access channels based upon the non-strict classification. The storage command classification includes optimistically matching command execution orders during the non-strict classification to maximize system throughput. The storage system includes providing a flow table format that supports both exact command order matching and optimistic command order matching. The non-strict classification includes determining whether to use a virtual local area storage information or media access controller information during the classification.

### Asymmetrical Processing Architecture

The method and apparatus of the present invention is capable of implementing asymmetrical multi-processing wherein processing resources are partitioned for processes and flows. The partitions can be used to implement SSD functions by using strands of a multi-stranded processor, or Chip Multi-Threaded Core Processor (CMT) to implement key low-level functions, protocols, selective off-loading, or even fixed-function appliance-like systems. Using the CMT architecture for offloading leverages the traditionally larger processor teams and the clock speed benefits possible with custom methodologies. It also makes it possible to leverage a high capacity memory-based communication instead of an I/O interface. On-chip bandwidth and the higher bandwidth per pin supports CMT inclusion of storage interfaces and storage command classification functionality.

Asymmetrical processing in the system of the present invention is based on selectively implementing, off-loading, or optimizing specific commands, while preserving the SSD functionality already present within the operating system of the local server or remote participants. The storage offloading can be viewed as granular slicing through the layers for specific flows, functions or applications. Examples of the offload category include: (a) bulk data movement (NFS client, RDMA, iSCSI); (b) storage command overhead and latency reduction; (c) zero copy (application posted buffer management); and (d) scalability and isolation (command spreading from a hardware classifier).

Storage functions in prior art systems are generally layered and computing resources are symmetrically shared by layers that are multiprocessor ready, underutilized by layers that are not multiprocessor ready, or not shared at all by layers that have coarse bindings to hardware resources. In some cases, the layers have different degrees of multiprocessor readiness, but generally they do not have the ability to be adapted for scaling in multiprocessor systems. Layered systems often have bottlenecks that prevent linear scaling.

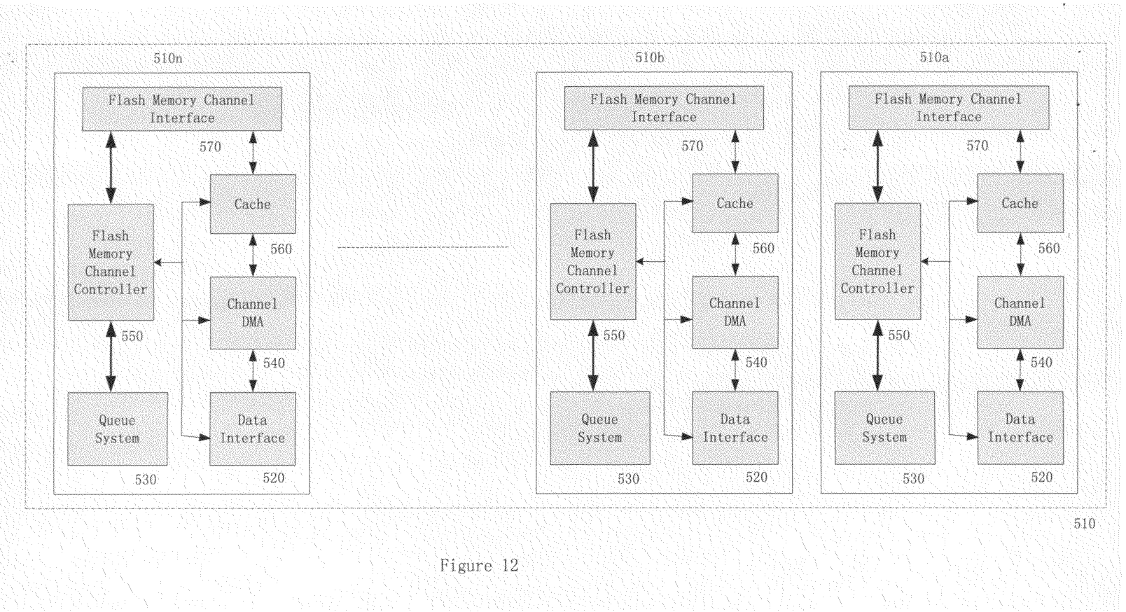

In prior art systems, time slicing occurs across all of the layers, applications, and operating systems. Also, in prior art systems, low-level SSD functions are interleaved, over time, in all of the elements. The present invention implements a method and apparatus that dedicates processing resources rather than utilizing those resources as time sliced. The dedicated resources are illustrated in FIG. 12.

The advantage of the asymmetrical model of the present invention is that it moves away from time slicing and moves toward “space slicing.” In the present system, the channel processors are dedicated to implement a particular SSD function, even if the dedication of these processing resources to a particular storage function sometimes results in “wasting” the dedicated resource because it is unavailable to assist with some other function.

In the method and apparatus of the present invention, the allocation of processing entities (processor cores or individual strands) can be allocated with fine granularity. The channel processor that are defined in the architecture of the present invention are desirable for enhancing performance, correctness, or for security purposes (zoning).

FIG. 1 also shows N storage interface instances 110. Each of the interfaces could have multiple links. The system of the present invention comprises aggregation and policy mechanisms which makes it possible to apply all of the control and the mapping of the channel processors 510a-510n to more than one physical interface.

In the asymmetrical processing system of the present invention, fine or coarse grain processing resource controls and memory separation can be used to achieve the desired partitioning. Furthermore it is possible to have a separate program image and operating system for each resource. Very “coarse” bindings can be used to partition a large number of processing entities (e.g., half and half), or fine granularity can be implemented wherein a single strand of a particular core can be used for a function or flow. The separation of the processing resources on this basis can be used to define partitions to allow simultaneous operation of various operating systems in a separated environment or it can be used to define two interfaces, but to specify that these two interfaces are linked to the same operating system.

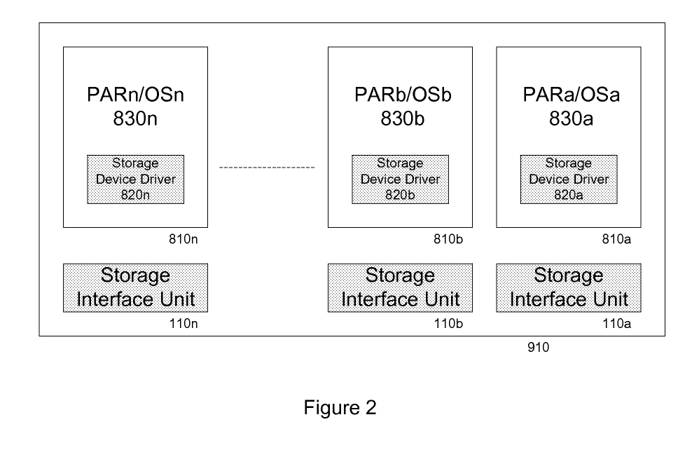

Referring to FIG. 2, a block diagram of a software view of the storage system 100 is shown. More specifically, a storage system software stack 810 includes one or more instantiations of a storage interface unit device driver 820, as well as one or more operating systems 830 (e.g., OSa, OSb, OSn). The storage interface unit 110 interacts with the operating system 830 via a respective storage interface unit device driver 820.

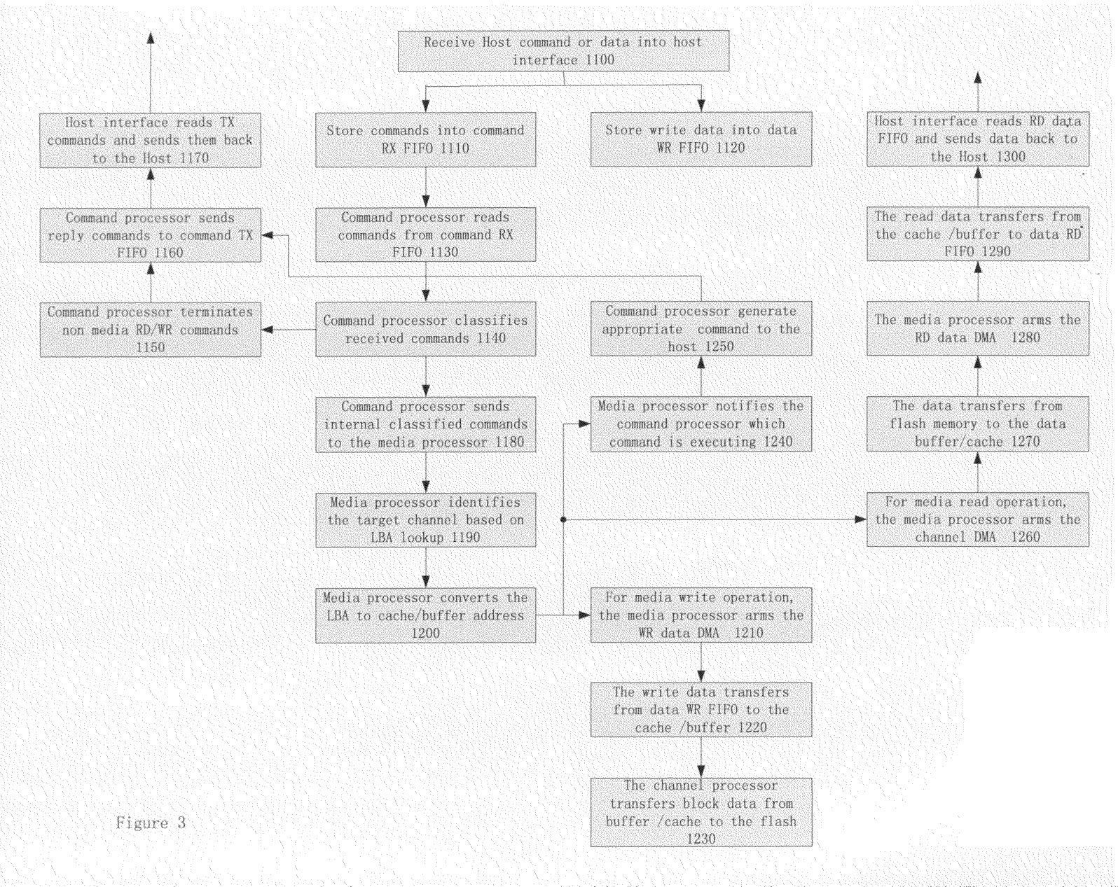

FIG. 3 shows the flow of storage command data and associated control signals in the system of the present invention from the operational perspective of receiving incoming storage command data and transmitting storage command data. The storage interface 110 is comprised of a plurality of physical storage interfaces that provide data to a plurality of storage protocol processors. The storage protocol processors are operable connected to a command processor and a queuing layer comprising a plurality of queues.

As was discussed above, the queues also hold “events” and therefore, are used to transfer messages corresponding to interrupts. The main difference between data and events in the system of the present invention is that data is always consumed by global buffer/cache memory, while events are directed to the channel processor.

Somewhere along the path between the storage interface unit 110 and the destination channel processor, the events are translated into a “wake-up” signal. The command processor determines which of the channel processor will receive the interrupt corresponding to the processing of a storage command of data. The command processor also determines where in the command queue a data storage command will be stored for further processing.

### Storage Interface Unit Overview

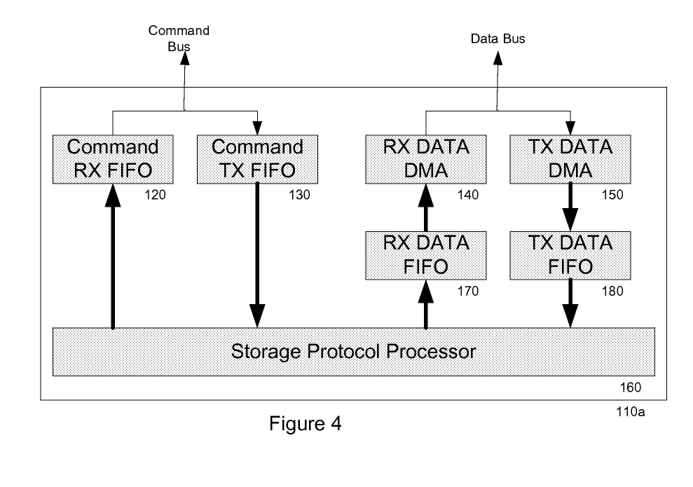

Referring to FIG. 4, a block diagram of a storage interface unit 110 is shown. The storage interface unit 110 includes a receive command FIFO module 120, a transmit command FIFO module 130, a receive data FIFO/DMA module 140, a transmit data FIFO/DMA module 150, and a storage protocol processor module 160.

Each of the modules within the storage interface unit 110 includes respective programmable input/output (PIO) registers. The PIO registers are distributed among the modules of the storage interface unit 110 to control respective modules. The PIO registers are where memory mapped I/O loads and stores to control and status registers (CSRs) are dispatched to different functional units.

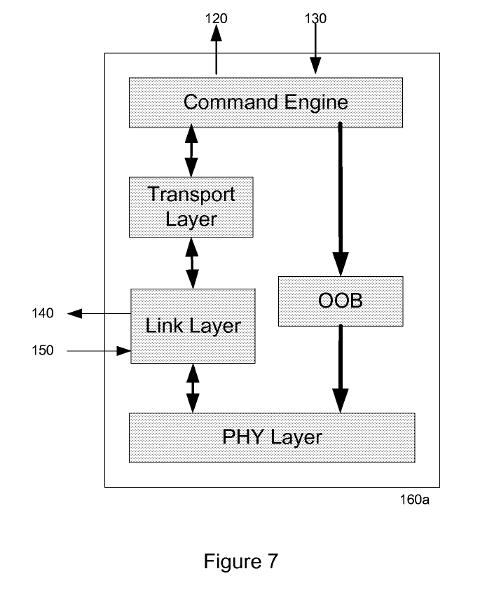

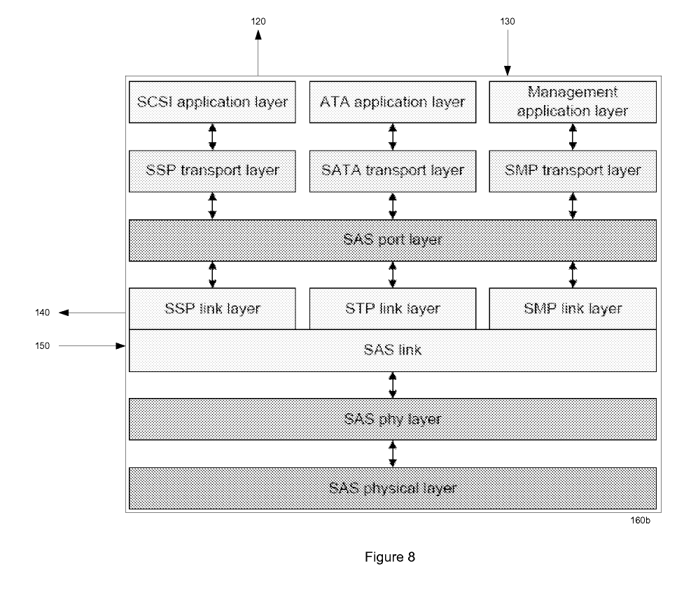

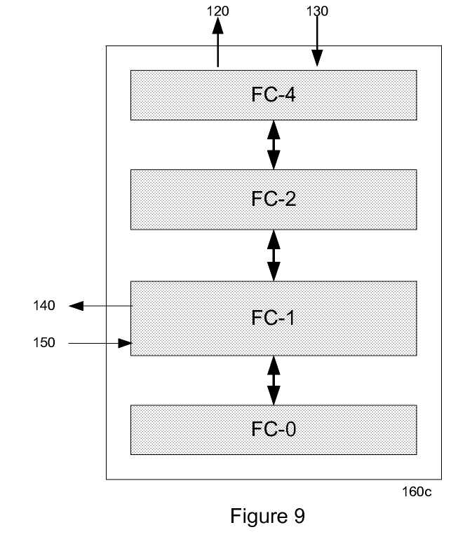

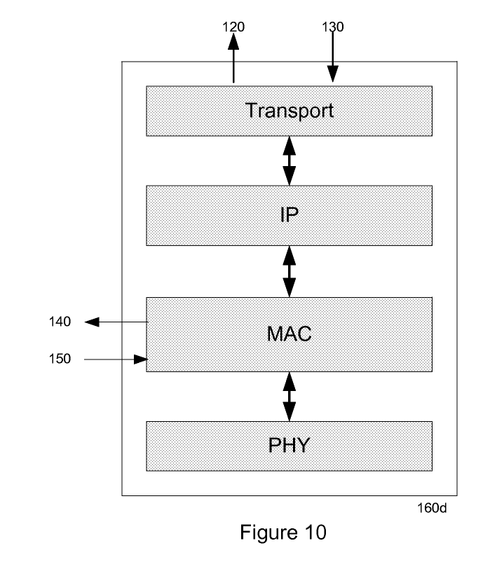

The storage protocol processor module 160 provides support to different storage protocols. FIG. 7 shows the layered block diagram of a SATA protocol processor. FIG. 8 shows the layered block diagram of a SAS protocol processor. FIG. 9 shows the layered block diagram of a Fiber Channel protocol processor. FIG. 10 shows the layered block diagram of an iSCSI protocol processor.

The storage protocol processor module 160 supports multi-protocol and statistics collection. Storage commands received by the module are sent to the RX command FIFO 120. Storage data received by the module are sent to the RX data FIFO 170. The media processor arms the RX DMA module 140 to post the FIFO data to the global buffer/cache module 710 via the interconnect module 310. Transmit storage commands are posted to the TX command FIFO 130 via the command processor 210. Transmit storage data are posted to the TX data FIFO 180 via the interconnect module 310 using TX DMA module 150. Each storage command may include a gather list.

The storage protocol processor may also support serial to parallel or parallel to serial data conversion, data scramble and descramble, data encoding and decoding, and CRC check on both receive and transmit data paths via the receive FIFO module 170 and the transmit FIFO module 180, respectively.

Each DMA channel in the interface unit can be viewed as belonging to a partition. The CSRs of multiple DMA channels can be grouped into a virtual page to simplify management of the DMA channels.

Each transmit DMA channel or receive DMA channel in the interface unit can perform range checking and relocation for addresses residing in multiple programmable ranges. The addresses in the configuration registers, storage command gather list pointers on the transmit side and the allocated buffer pointer on the receive side are then checked and relocated accordingly.

The storage system 100 supports sharing available system interrupts. The number of system interrupts may be less than the number of logical devices. A system interrupt is an interrupt that is sent to the command processor 210 or the media processor 410. A logical device refers to a functional block that may ultimately cause an interrupt.

A logical device may be a transmit DMA channel, a receive DMA channel, a channel processor or other system level module. One or more logical conditions may be defined by a logical device. A logical device may have up to two groups of logical conditions. Each group of logical conditions includes a summary flag, also referred to as a logical device flag (LDF). Depending on the logical conditions captured by the group, the logical device flag may be level sensitive or may be edge triggered. An unmasked logical condition, when true, may trigger an interrupt.

### Storage Command Processor Overview

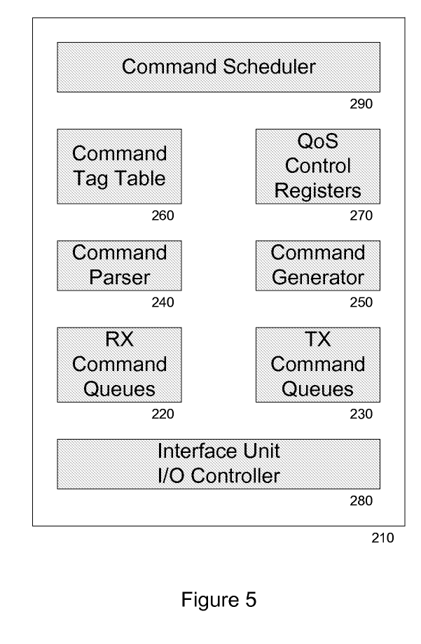

Referring to FIG. 5, a block diagram of the storage command processor module 210 is shown. The module is coupled to the interface unit module 110 via the command FIFO buffers 120 and 130. The receive command FIFO module 120 and transmit command FIFO module 130 are per port based. For example, if the storage interface unit 110 includes two storage ports, then there are two sets of corresponding FIFO buffers, if the storage interface unit 110 includes four storage ports, then there are four sets of corresponding FIFO buffers.

The storage command processor module 210 includes a RX command queue 220, a TX command queue 230, a command parser 240, a command generator 250, a command tag table 260, and a QoS control register module 270. The storage command processor module 210 also includes an Interface Unit I/O control module 280 and a media command scheduler module 290.

The storage command processor module 210 retrieves storage commands from the RX command FIFO buffers 120 via the Interface Unit I/O control module 280. The RX commands are classified by the command parser 240 and then sent to the RX command queue 220.

The storage command processor module 210 posts storage commands to the TX command FIFO buffers 120 via the Interface Unit I/O control module 280. The TX commands are classified to the TX command queue 230 based on the index of the target Interface Unit 110. The Interface Unit I/O control module 280 pulls out the TX commands from the TX command queue 230 and sends out to the corresponding TX command FIFO buffer 130.

The command parser 240 classifies the RX commands based on the type of command, the LBA of the target media, and the requirements of QoS. The command parser also terminates commands that are not related to the media read and write.

The command generator 250 generates the TX commands based on the requests from either the command parser 240 or the media processor 410. The generated commands are posted to the TX command queue 230 based on the index of the target Interface Unit.

The command tag table 260 records the command tag information, the index of the source Interface Unit, and the status of command execution.

The QoS control register module 270 records the programmable information for command classification and scheduling.

The command scheduler module 290 includes a strict priority (SP) scheduler module, a deficit round robin (DRR) scheduler module as well as a round robin (RR) scheduler module. The scheduler module serves the storage Interface Units within the storage interface subsystem 110 in either DRR scheme or RR scheme. For the commands coming from the same Interface Unit, the commands shall be served based on the command type and target LBA. The TCQ or NCQ commands are served strictly based on the availability of the target channel processor. When multiple channel processors are available, they are served in RR scheme. For the non-TCQ and non-NCQ commands, they are served in FIFO format depending on the availability of the target channel processor.

### Storage Media Processor Overview

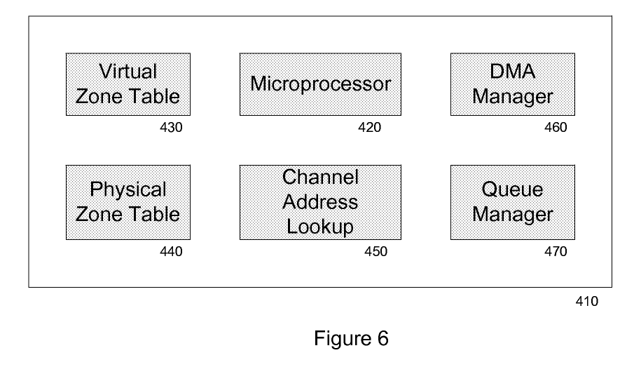

Referring to FIG. 6, a block diagram of the storage media processor module 410 is shown. The module is coupled to the interface unit module 110 via the DMA manager 460. The module is also coupled to the command processor module 210 via the command scheduler 290. The module is also coupled to the channel processor module 510 via the DMA manager 460, and the queue manager 470.

The storage media processor module 410 includes a Microprocessor module 420, Virtual Zone Table module 430, a Physical Zone Table module 440, a Channel Address Lookup Table module 450, a DMA Manager module 460, and a Queue Manager module 470.

The Microprocessor module 420 includes one or more microprocessor cores. The module may operate as a large simultaneous multiprocessing (SMP) system with multiple partitions. One way to partition the system is based on the Virtual Zone Table. One thread or one microprocessor core is assigned to manage a portion of the Virtual Zone Table. Another way to partition the system is based on the index of the channel processor. One thread or one microprocessor core is assigned to manage one or more channel processors.

The Virtual Zone Table module 430 is indexed by host logic block address (LBA). It stores of entries that describe the attributes of every virtual strip in this zone. One of the attributes is host access permission that is capable to allow a host to only access a portion of the system (host zoning). The other attributes include CacheIndex that is cache memory address for this strip if it can be found in cache; CacheState is to indicate if this virtual strip is in the cache; CacheDirty is to indicate which module's cache content is inconsistency with flash; and FlashDirty is to indicate which modules in flash have been written. All the cache related attributes are managed by the Queue Manager module 470.

The Physical Zone Table module 440 stores the entries of physical flash blocks and also describe the total lifetime flash write count to each block and where to find a replacement block in case the block goes bad. The table also has entries to indicate the corresponding LBA in the Virtual Zone Table.

The Channel Address Lookup Table module 450 maps the entries of physical flash blocks into the channel index.

The DMA Manager module 460 manages the data transfer between the channel processor module 510 and the interface unit module 110 via the data interconnect module 310. The data transfer may be directly between the data FIFO buffers in the interface module 110 and the cache module in the channel processor 510. The data transfer may also be between the data FIFO buffers in the interface module 110 and the global buffer/cache module 710. The data transfer may also be between the channel processor 510 and the global buffer/cache module 710.

### Storage Channel Processor Overview

Referring to FIG. 12, a block diagram of the storage channel processor module 510 is shown. The module is coupled to the interface unit module 110 via the media processor 410 and the data interconnect module 310. The module is also directly coupled to the nonvolatile memory module 610.

The storage channel processor module 510 includes a Data Interface module 520, a Queue System module 530, a DMA module 540, a Nonvolatile memory Control module 550, a Cache module 560, and a Flash Interface module 570. The channel processor uses the DMA module 540 and the Data Interface module 520 to access the global data buffer/cache module 710.

The Queue System module 530 includes a number of queues for the management of nonvolatile memory blocks and cache content update. The Cache module 560 may be a local cache memory or a mirror of the global cache module 710. The cache module collects the small sectors of data and writes them to the nonvolatile memory in chucks of data.

The Nonvolatile memory Control module 550 and the Flash Interface module 570 work together to manage the read and write operations to the nonvolatile memory modules 610. Since the write operations to the nonvolatile memory may be slower than the read operations, the flash controller may pipeline the write operations within the array of nonvolatile memory dies/chips.

### Nonvolatile Memory System Overview

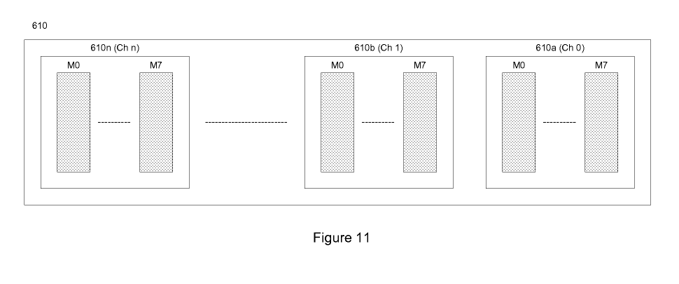

Referring to FIG. 11, a block diagram of the nonvolatile memory system 610 is shown. The module is coupled to the rest of the storage system via the channel processor 510.

The nonvolatile memory system 610 includes a plurality of nonvolatile memory modules (610a, 610b, . . . , 610n). Each nonvolatile memory module includes a plurality of nonvolatile memory dies or chips. The nonvolatile memory may be one of a Flash Memory, Ovonic Universal Memory (OUM), and Magnetoresistive RAM (MRAM).

### Storage System Software Stack

Referring again to FIG. 2, the interface unit device driver 820 assists an operating system 830 with throughput management and command handshaking.

Referring to FIG. 3, a flow diagram of a storage command flows through the storage system 100.

The storage system software stack 910 migrates flows to insure that receive and transmit commands meet the protocol requirements.

The storage system software stack 910 exploits the capabilities of the storage interface unit 110. The command processor 210 is optionally programmed to take into account the tag of the commands. This programming allows multiple storage interface units 110 to be under the storage system software stack 910.

When the storage interface unit 110 is functioning in an interrupt model, when a command is received, it generates an interrupt, subject to interrupt coalescing criteria. Interrupts are used to indicate to the command processor 210 that there are commands ready for processing. In the polling mechanism, reads the command FIFO buffer status are performed to determine whether there are commands to be processed.

### OTHER EMBODIMENTS

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while particular architectures are set forth with respect to the storage system and the storage interface unit, it will be appreciated that variations within these architectures are within the scope of the present invention. Also, while particular storage command flow descriptions are set forth, it will be appreciated that variations within the storage command flow are within the scope of the present invention.

Also for example, the above-discussed embodiments include modules and units that perform certain tasks. The modules and units discussed herein may include hardware modules or software modules. The hardware modules may be implemented within custom circuitry or via some form of programmable logic device. The software modules may include script, batch, or other executable files. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules and units is for illustrative purposes. Alternative embodiments may merge the functionality of multiple modules or units into a single module or unit or may impose an alternate decomposition of functionality of modules or units. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for scaling a SSD system comprising: providing at least one storage interface, each storage interface associating a plurality of nonvolatile memory access channels, providing a flexible association between storage commands and a plurality of nonvolatile memory modules via the plurality of nonvolatile memory access channels.

2. The method of claim 1 wherein the flexible association is based upon stateful association.

3. The method of claim 1 wherein the flexible association is based upon stateless association.

4. The method of claim 1 wherein the flexible association is based upon storage interface zoning.

5. The method of claim 1 wherein each of the plurality of nonvolatile memory access channels includes a channel context.

6. The method of claim 1 wherein the flexible association is provided via a storage command classification processor and a media processor using both hardware and firmware.

7. The method of claim 1 wherein each of the plurality of nonvolatile memory modules includes a number (Nf) of nonvolatile memory dies or chips.

8. The method of claim 1 wherein the storage interface is one of an ATA/IDE, SATA, SCSI, SAS, Fiber Channel, and iSCSI interface.

9. The channel context of claim 4 comprising: a channel DMA, a cache, a cache controller, a nonvolatile memory interface controller, and a queue manager.

10. The cache as recited in claim 9, is one of a Static Random Access Memory (SRAM), Dynamic Random Access Memory (DRAM), Double Data Rate (DDR) DRAM, and DDR2 DRAM.

11. The cache as recited in claim 9, is of size at least Nf times of 4 KBytes. The cache controller stores write data to the flash module when the collected data size is more than Nf times of 2 KBytes.

12. The method of claim 4 further comprising: the allocation of resources for system load balancing and for selectively allowing access to data only to certain storage interfaces.

13. The method of claim 6 further comprising: performing a non-strict classification on a storage command queue; associating the storage command with one of the plurality of nonvolatile memory access channels based upon the non-strict classification criteria and access address.

14. The method of claim 6 further comprising: optimistically matching during the non-strict classification to maximize the overall throughput of the access channels.

15. The method of claim 6 wherein: the non-strict classification includes determining whether to use cache information or nonvolatile memory information during the classification.

16. The command classification processor as recited in claim 6 terminating all the commands other than media read and write commands.

17. The media processor as recited in claim 6 terminating the media read and write commands and arming all the channel DMAs and interface DMAs for media data access.

18. The storage interface as recited in claim 8 having a multi-layer storage protocol processor.

19. The storage protocol processor as recited in claim 18 is one of an ATA/IDE, SATA, SCSI, SAS, Fiber Channel, and iSCSI protocol processor.

20. The storage protocol processor as recited in claim 18 separating the storage commands and data to different FIFO buffers for parallel processing.
